(19) United States
(12) Patent Application Publication
(10) Pub. No.: US 2010/0137155 A1
(43) Pub. Date: Jun. 3, 2010

(54) BIOSENSOR, METHOD FOR FABRICATING THE SAME, DETECTING METHOD UTILIZING THE SAME

(75) Inventors: Yoshiroh Akagi, Osaka-shi Osaka (JP); Kazuo Ban, Nara-shi Nara (JP); Kyoko Seo, Toyohashi-shi Aichi (JP); Naoya Ichimura, Kyoto-shi Kyoto (JP); Atsushi Mizusawa, Kyoto-shi Kyoto (JP)

Correspondence Address: BIRCH STEWART KOLASCH & BIRCH, PO BOX 747, FALLS CHURCH, VA, 22040-0747, US

(73) Assignee: SHARP KABUCHIKI KAISHA, Osaka-shi, Osaka (JP)

(21) Appl. No.: 12/376,712

(22) PCT Filed: Aug. 2, 2007
(86) PCT No.: PCT/JP2007/065154

§ 371 Date: May 15, 2009

(30) Foreign Application Priority Data
Aug. 8, 2006 (JP) 2006-215751

(51) Int. Cl. C40B 30/04; C40B 40/10; C40B 50/14

(52) U.S. Cl. 506/9; 506/18; 506/30

(57) ABSTRACT

A biosensor capable of highly sensitive detection of a recognition target substance while having structural stability is provided at low cost. The biosensor is for capturing and detecting a recognition target substance and includes a linker made of a hydrocarbon compound having two or more particular functional groups, a peptide serving as a molecular recognition substance directly bonded to one particular functional group of the linker, and a support directly bonded to the other particular functional group of the linker. Preferably, the particular functional groups each are a reaction product functional group of an epoxy group and an amino group. The peptide is an artificially synthesized peptide including three or more consecutive amino acid sequences, among amino acid sequences of a natural immunoglobulin, that exist in a part corresponding to a hypervariable area of the natural immunoglobulin.

### TECHNICAL FIELD

The present invention relates to a biosensor for detecting proteins and the like, and more especially to a biosensor in which a peptide as a molecular recognition substance is immobilized on a support via a linker.

### BACKGROUND ART

In recent years, in order to shorten the time for analysis and to simplify handling, such a technique has been proposed that immobilizes and arranges in a highly dense manner molecular recognition substances (e.g., proteins and peptides) that react specifically with recognition target substances in a reaction area of a microchip (see, e.g., non-patent document 1).

[Non-patent document 1] Karube, Masao. Biosensor: CMC Publishing, 2002.

Protein is stable when coexisting with various substance groups in living bodies, but when isolated, may change its structure or be deactivated by being influenced by temperature, humidity, pH, oxygen, light, contaminants, dirt, rot, and the like. Protein may also degenerate on contact with the surfaces of solids (chips). Further, when an enzyme such as protease exists in a sample containing a recognition target substance, protein may be hydrolyzed. Thus, attempts to constitute devices that eliminate all these causes complicate the entire devices, causing increased appliance troubles and increased cost. Further, isolated protein is expensive in itself, the above-described technique using isolated protein causes increased cost for the biosensor device.

Contrarily, peptide does not possess a complicated three-dimensional structure as protein. Thus, peptide does not involve structural change or deactivation and therefore is considered to be useful as a molecular recognition substance. However, when peptide is immobilized directly to a chip (a substrate or the like), the free motion of the peptide is hindered and the molecule recognizing ability thereof is lost.

In view of this, a linker is essential for linking the chip and the peptide with some distance secured therebetween.

As a technique to immobilize peptide to a chip with a linker, patent document 1 discloses the following technique.

[Patent document 1] Published Japanese Translation No. 2003-536073 of the PCT International Publication.

Patent document 1 relates to a protein binding agent containing an anchor segment bonded stably to the surface of a substrate, a peptide mimetic protein binding agent, and a linker segment for linking the anchor segment and the peptide mimetic segment and then separating them. This technique is said to be able to provide a protein binding agent that eliminates the possibility of deactivation.

However, the technique according to patent document 1 requires the following three complicated steps:

(1) Linking the peptide mimetic protein binding agent and the anchor segment;
(2) Linking the linker segment and the anchor segment; and
(3) Linking the anchor segment and the substrate.

This poses the problem of increased cost.

Patent document 2 proposes a technique that uses glutaraldehyde (GA) as a linker.

[Patent document 2] Japanese Examined Patent Publication No. 61-8942.

The technique according to patent document 2 is a technique to immobilize an antibody and a protein such as an enzyme to a solid having an amino group such as chitosan through glutaraldehyde. Although glutaraldehyde possesses excellent reactivity as a linker, it is also a compound widely used as disinfectant and thus deactivates protein and the like. Further, glutaraldehyde is also a substance that lacks flexibility and thus hardens protein and the like during immobilization, creating a possibility of undermining the molecule recognizing function.

Incidentally, methods for obtaining a peptide include decomposing a natural protein and artificial synthesis. In order to decompose a natural protein, it is necessary to first isolate a particular protein and then decompose it, which makes acquirement of natural peptide significantly costly. Contrarily, the artificial synthesis method enables any peptide to be acquired at low cost, but use of a peptide that is outside a molecular recognition portion of a detection target protein will not enable a desired molecule to be detected, Also, synthesis of a peptide containing a portion unnecessary for molecular recognition only increases cost and is not effective.

Thus, it is rational to first identify a minimum-unit amino acid sequence (peptide) that is essential to detection of a desired molecule, obtain the amino acid sequence by decomposing a natural peptide or by artificial synthesis, and use the obtained amino acid sequence as a molecular identification substance.

### DISCLOSURE OF THE INVENTION

### Problems to be Solved by the Invention

The present invention has been made in view of the above considerations. It is an object of the present invention to provide an easily used biosensor that is superior in molecular recognizability, preservation stability, and economy.

In order to solve the above-described problems, a biosensor according to a first aspect of the present invention is a biosensor for capturing and detecting a recognition target substance and includes: a peptide serving as a molecular recognition substance; a linker made of a hydrocarbon compound having two or more particular functional groups; and a support, wherein the peptide is directly bonded to one of the particular functional groups of the linker while the support is directly bonded to the other particular functional group of the linker bonded to the peptide.

With this configuration, since a peptide is used as a molecular recognition substance, the structural stability improves.

Also, the peptide is directly bonded to one of the particular functional groups of the linker while the support is directly bonded to the other particular functional group of the linker bonded to the peptide. This eliminates the need for complicated reaction steps as in patent document 1.

The term “peptide” encompasses peptides in which functional groups of amino acids constituting the peptides are modified, as well as peptides with peptide bonds of two or more amino acids. Also, the term “particular functional group” means an epoxy-derived functional group formed by reaction of an epoxy group and a functional group reactive to the epoxy group. For example, when an epoxy group and an amino group of peptide react to one another and thus amino alcohol (R₁—CH(OH)—CH₂—NHR₂; R₁ denotes a structure of the linker other than the epoxy and R₂ denotes a structure of the peptide other than the amino group) occurs, the “—CH(OH)—CH₂—” serves as the particular functional group. It should be noted that the particular functional group existing at the bonding portion of the peptide and the liker may differ from that existing at the bonding portion of the support and the linker.

In the above configuration, the particular functional groups each may be a reaction product functional group of an epoxy group and an amino group.

With this configuration, the epoxy group and the amino group quickly have a bonding reaction, thereby facilitating the preparation of the biosensor. In order to realize this configuration: as a linker molecule (a molecule that serves as a basis of the linker), a linker molecule having two or more epoxy groups is preferably used; as the peptide, a peptide that has a not-modified amino group at an N-terminal or a peptide that contains lysine or arginine having two amino groups is preferably used; and as the support, a compound having an amino group is preferably used.

In the above configuration, such a configuration may be configured that one of the two particular functional groups is located at one terminal of the linker, and the other particular functional group is located at the other terminal of the linker.

With this configuration, the linker will not adversely affect the molecular recognizability of the peptide.

As a structure of such a linker other than a portion for the particular functional group, a structure having hydrophilicity, hydrophobicity, or amphiphaticity may be used, preferably a hydrocarbon structure. This structure may contain a branched structure, an unsaturated bond, a cyclic structure or an aromatic structure. Also, a structure containing oxygen such as an ether group, an carboxyl group, and an carbonyl group may be contained. Among the foregoing, use of a linker having a polyalkylene oxide structure represented by “—O—CH₂—CHR—; R denoting a hydrogen atom or an alkyl group” is preferable in that a suitable degree of amphiphaticity is obtained.

Also, as the peptide, an artificially synthesized peptide may be used. An artificially synthesized peptide is preferable in that the cost can be reduced and the reproducibility can be improved.

Also, the artificially synthesized peptide may be identical to an amino acid sequence in a hypervariable area of an antibody protein, or an artificially synthesized peptide in which some functional group of an amino acid of the amino acid sequence is modified, or an artificially synthesized peptide in which another amino acid is added to a C terminal and/or an N terminal of the amino acid sequence, or an artificially synthesized peptide in which a part of the amino acid sequence is changed.

Since an amino acid sequence in the hypervariable area of an antibody protein is a part that exhibits antigenic specificity most apparently, use of an amino acid sequence in this part provides a peptide of high antigenic specificity. Thus, use of an amino acid sequence in the hypervariable area enables it to minimize the number of amino acids essential for detecting the desired molecule, thereby reducing the cost for the artificial synthesis of peptide serving as a molecule recognition substance.

This artificially synthesized peptide may be an artificially synthesized peptide in which some functional group of an amino acid of an amino acid sequence in a hypervariable area of an antibody protein is modified, or an artificially synthesized peptide in which another amino acid is added to a C terminal and/or an N terminal of the amino acid sequence, or an artificially synthesized peptide in which a part of the amino acid sequence is changed, or a combination of the foregoing.

In the above configuration, an amino acid at a C terminal and/or an N terminal of the artificially synthesized peptide may be cysteine.

In order to limit the bonding location of the peptide and the linker to the C terminal side, such a configuration may be employed that an amino group of an amino acid at the N terminal of the artificially synthesized peptide is modified, the amino acid at the C terminal of the artificially synthesized peptide is an amino acid having primary amine on a side chain, and an amino group of an amino acid at the C terminal is bonded to the particular functional group. In the case where a peptide other than a peptide terminal contains an amino acid having primary amine on a side chain, it is possible to modify an amino group other than an α-amino group of this amino acid.

As the amino acid having primary amine on a side chain, lysine may be used.

Also, the length of the linker is preferably from 0.5 to 10 nm, more preferably from 0.8 to 7.0 nm. If the length of the linker is excessively small, the support and the peptide cannot be sufficiently separated, while if the length of the linker is excessively large, the linker may bend to undermine the molecule recognition function of the peptide.

Also, a single kind of peptide may be immobilized to the support.

This configuration secures that a single kind of recognition target substance is detected.

Also, two or more kinds of peptides may be immobilized to the support, the peptides existing in a random manner.

This configuration provides advantageous effects including the following. For example, in the case where the recognition target substance has a plurality of recognition parts, immobilizing a plurality of kinds of peptides corresponding to respective recognition parts enables the plurality of kinds of peptides to capture one recognition target substance, thereby enhancing the molecule recognizing effect. Also, in the case where there is a possibility that the sample contains a plurality of kinds of recognition target substances, only one analysis operation is carried out in determining whether at least one of the plurality of kinds of recognition target substances is contained or none is contained.

In the above configuration, such a configuration may be employed that the support has formed thereon a molecule recognition area A where a plurality of peptides of a single kind are immobilized, and a molecule recognition area B where a plurality of peptides of a single kind different from the foregoing are immobilized.

With this configuration, two kinds of recognition target substances can be analyzed simultaneously. In this configuration, three or more kinds of recognition target substances may be formed, and it is even possible that the molecule recognition area A is where peptides of two or more kinds are immobilized and the molecule recognition area B is where peptides of two or more kinds different from those in the molecule recognition area A are immobilized.

While the support may be of any form, use of a substrate, a solid particle, a film, a fiber, a gel, or the like is useful. However, generally, there is a case where it is difficult to dispose a functional group to bond to an epoxy group on the surface of the substrate or the like itself. In this case, it is preferable to form on the surfaces of the foregoing a thin film (thin film serves as the support) of a compound having a functional group that bonds to the epoxy group.

Also, the thin film may be chitosan of 50 to 400 nm thick.

In order to solve the above-described problems, a method for producing a biosensor according to a second aspect of the present invention includes the step of bringing a mixture solution of a peptide serving as a molecular recognition substance and a linker molecule made of a hydrocarbon compound having epoxy groups at both terminals thereof into contact with a support having on a surface thereof a functional group that bonds to an epoxy group, in order to directly bond the peptide to the linker molecule and directly bond the linker molecule to the support.

With this configuration, the above one step enables a bonding reaction between an amino group of the peptide and one of the epoxy groups of the linker molecule and a bonding reaction between the functional group of the support and the other epoxy group of the linker molecule, making it possible to directly bond the peptide to the linker molecule and directly bond the linker molecule to the support. This simplifies the production process.

As the functional group to bond to the epoxy group, a compound having nucleophilicity may be used, and as such a functional group, an amino group, a hydroxyl group, or the like may be used.

In the above configuration, the concentration of the peptide contained in the mixture solution may be from 0.001 to 2.0 mole/L.

Also, the concentration of the linker molecule contained in the mixture solution may be from 0.001 to 4.0 mole/L.

Also, the linker molecule may be polyalkylene oxide diglycidyl ether or monoalkylene oxide diglycidyl ether represented by G-(O—CH₂CHR—)ₙ—O-G, where R denotes a hydrogen atom or an alkyl group, G denotes a glycidyl group, and n denotes an integer of 1 or greater.

Also, the functional group on the surface of the support to bond to the epoxy group may be an amino group.

Also, the support may be a thin film formed by applying a chitosan solution having chitosan dissolved in an acid solvent solution to a surface of a substrate, a solid particle, a fiber, or a gel.

Also, the chitosan solution may have a viscosity of from 100 to 1000 Pa·S at 25° C.

Also, the chitosan thin film may have a thickness of from 50 to 400 nm.

In order to solve the above-described problems, a detection method according to a third aspect of the present invention is a method for detecting a recognition target substance using a biosensor having cysteine contained in an amino acid constituting the above-described peptide, the method including: a first step of forming a peptide/recognition target substance composite by reacting a peptide with the recognition target substance; a second step of forming peptide/recognition target substance composite/fluorescent substance-added antibody material by reacting the peptide/recognition target substance composite with a fluorescent substance-added antibody material; a third step of rinsing an excessive portion of the fluorescent substance-added antibody material; a fourth step of detecting the amount of a fluorescent substance; a fifth step of adding gold colloid in order to react cysteine with the gold colloid; a sixth step of rinsing an excessive portion of the gold colloid and the fluorescent substance-added antibody material; and a seventh step of, after the sixth step, detecting the amount of the fluorescent substance. The amount of the recognition target substance is measured from a difference between the amount of the fluorescent substance detected in the fourth step and the amount of the fluorescent substance detected in the seventh step.

When protein is detected, the protein serving as a recognition target substance is adsorbed by non-specific adsorption to the surface of a substance or the like constituting the biosensor, and a detection signal associated with this is also detected, thereby making it impossible to accurately measure the mass of the protein. However, by using the above-claimed method, gold colloid is introduced after measuring the amount of light emission in the fourth step, thereby removing the recognition target substance from the peptide/recognition target substance composite and instead reacting the gold colloid to the cysteine. This reduces light emission by an amount corresponding to the amount of the peptide/recognition target substance composite. Thus, the amount of reduction of light emission can be detected as an accurate amount of the protein.

In order to solve the above-described problems, a detection method according to a fourth aspect of the present invention is a method for detecting a recognition target substance using the above-claimed biosensor, the method including: a first step of forming a peptide/recognition target substance composite by reacting a peptide with the recognition target substance; a second step of forming peptide/recognition target substance composite/cysteine-added peptide by reacting the peptide/recognition target substance composite with a peptide having cysteine added to a terminal; a third step of rinsing an excessive portion of the peptide having cysteine added to a terminal; a fourth step of adding gold colloid in order to react the cysteine with the gold colloid; a fifth step of rinsing an excessive portion of the gold colloid, and a sixth step of, after the sixth step, detecting the amount of color development of the gold colloid.

Also with this method, the amount of the recognition target substance can be detected accurately.

In order to solve the above-described problems, a biosensor according to a fifth aspect of the present invention includes: a peptide serving as a molecule capturing substance for capturing a particular molecule; a support for holding the peptide; and a linker for linking the peptide to the support. The peptide is an artificially synthesized peptide of a structure different from an immunoglobulin of living body. The linker is a hydrocarbon compound having at least two reactive functional groups. The artificially synthesized peptide is directly bonded to one of the reactive functional groups of the linker, and the support is directly bonded to another reactive functional group different from the foregoing reactive functional group.

With this configuration, since an artificially synthesized peptide having a structure different from a natural immunoglobulin is used as a molecule capturing substance, physical and chemical stability can be improved over the use of a natural immunoglobulin or a peptide derived from a natural immunoglobulin while at the same time reducing the cost for preparation of the sensor.

Also, since such a structure is employed that the peptide is directly bonded to one of the reactive functional groups of the linker and the support is directly bonded to another reactive functional group of the linker bonded to the peptide, excellent structural stability can be obtained. Also with this structure, such a state is obtained that the peptide protrudes outwardly through the linker, resulting in high capturing efficiency of the particular molecule.

As used herein, the term “artificially synthesized peptide of a structure different from an immuno globulin of living body” means a peptide having a structure that is partially or completely different from an immune protein of living body. That is, the term means one in which a different amino acid is added to whole or part of the amino acid sequence of an immune protein of living body, or one in which whole or part of the amino acid sequence of the immune protein is changed.

In the above configuration, the artificially synthesized peptide may include three or more consecutive amino acid sequences among amino acid sequences of a natural immunoglobulin, the three or more consecutive amino acid sequences existing in a part corresponding to a hypervariable area of the natural immunoglobulin.

Since an amino acid sequence in the hypervariable area of an immunoglobulin is a part that exhibits antigenic specificity most apparently, use of an amino acid sequence in this part provides a peptide of high antigenic specificity (high capturing ability of a particular molecule). In order to obtain this high antigenic specificity, it is preferable to include at least three consecutive amino acid sequences, among the amino acid sequences of the natural immunoglobulin, that exist in a part corresponding to the hypervariable area of the natural immunoglobulin.

Description will be made of a detecting method of the hypervariable area of the natural immunoglobulin.

(1) First, an antibody sample to which an amino acid sequencing (the Edman method) is carried out is determined. This amino acid sequencing is one by which analysis is carried out starting from the N terminal. Some proteins, however, have an N terminal amino acid blocked, thereby disabling the amino acid sequencing. In view of this, a sample without blockage is selected from a plurality of antibody samples.

(2) When the amino acid sequencing is carried out for several residues, an amino acid that is contained as an impurity is detected at the same time in addition to amino acids of the H chain and L chain. In view of this, the detected amino acids are classified into constituents of the H chain, constituents of the L chain, and impurities.

(3) It is known that antibodies derived from the same kind have the same basic structures. All H chain amino acid sequences of a known antibody are picked up from a gene database (e.g., GenBank (http://www.genome.jp/dbget-bin/www#bfind?genbank-today) and EMBL (http://www.genome.jp/dbget-bin/www#bfind?embl-today)), and are subjected to a homology comparison with respect to an amino acid sequence related to a target antibody kind (sub-type). When there is an amino acid sequence that agrees to an amino acid analyzed in (2), this antibody has an H chain without blockage. The same is carried out for the L chain to determine the presence or absence of blockage. In this manner, an antibody sample to which the amino acid sequencing is carried out is determined.

(4) Using the antibody sample determined in (3), an amino acid sequencing is carried out again to include a hypervariable area of a known antibody.

(5) At least five, preferably all, of the amino acid sequences based on antibody H chain gene sequence information recorded in the gene database such as EMBL and GenBank are picked up, and are subjected to a homology comparison. A sequence part area that corresponds to a hypervariable area of a known antibody (generally, approximately 20th to 40th, 50th to 70th, or 80th to 120th amino acids counted from the N terminal of the H chain and L chain of an immunoglobulin molecule) and that has a change rate of 20 or more obtained from the following formula is determined as the hypervariable area.

Change rate=The number of different amino acids in a given location/most general frequency of amino acids in the given location. [Formula 1]

In the above configuration, some of functional groups of amino acids constituting the three or more amino acid sequences may be modified by other functional groups.

Some of the amino acids constituting peptide possess functional groups rich in reactivity. If such a functional group is used as it is, the functional group reacts to something other than the particular molecule, creating a possibility of losing the particular molecule capturing ability of the peptide. In view of this, such a functional group is preferably modified by another functional group.

In the above configuration, assuming that an amino acid sequence composed of four consecutive amino acids forming a hypervariable area of a natural immunoglobulin is a hydrophobic amino acid sequence when three of the amino acids constituting the amino acid sequence each are a hydrophobic amino acid selected from a group consisting of isoleucine, phenylalanine, valine, leucine, methionine, tryptophan, alanine, glycine, cysteine, and tyrosine, and the other one amino acid is an amino acid other than the hydrophobic amino acid, then the artificially synthesized peptide may contain a synthesized hydrophobic amino acid sequence unit resulting from replacing the amino acid other than the hydrophobic amino acid in the hydrophobic amino acid sequence with a hydrophobic amino acid.

In the case of an amino acid sequence composed of four consecutive amino acids forming a hypervariable area of a natural immunoglobulin where three of the amino acids are hydrophobic and the other amino acid is non-hydrophobic, replacing the non-hydrophobic amino acid with a hydrophobic amino acid enhances the particular molecule capturing ability. It should be noted that any method may be employed in selecting four consecutive amino acids forming the hypervariable area.

In the above configuration, some functional groups of the amino acids constituting the synthesized hydrophobic amino acid sequence unit may be modified with other functional groups.

Some of the amino acids constituting peptide possess functional groups rich in reactivity. If such a functional group is used as it is, the functional group reacts with something other than the particular molecule, creating a possibility of losing the particular molecule capturing ability of the peptide. In view of this, such a functional group is preferably modified by another functional group.

In the above configuration, assuming that an amino acid sequence composed of four consecutive amino acids forming a hypervariable area of a natural immunoglobulin is a hydrophilic amino acid sequence when three of the amino acids constituting the amino acid sequence each are a hydrophilic amino acid selected from a group consisting of histidine, glutamic acid, asp aratic acid, glutamine, asp aragine, lysine, arginine, proline, threonine, and serine, and the other one amino acid is an amino acid other than the hydrophilic amino acid, then the artificially synthesized peptide may contain a synthesized hydrophilic amino acid sequence unit resulting from replacing the amino acid other than the hydrophilic amino acid in the hydrophilic amino acid sequence with a hydrophilic amino acid.

In the case of an amino acid sequence composed of four consecutive amino acids forming a hypervariable area of a natural immunoglobulin where three of the amino acids are hydrophilic and the other amino acid is non-hydrophilic, replacing the non-hydrophilic amino acid with a hydrophilic amino acid enhances the particular molecule capturing ability. The “four consecutive amino acids” in the above configuration are required to be within the hypervariable area, but not identified in advance. The term means “four consecutive amino acids” optionally selected from within the hypervariable area.

In the above configuration, some functional groups of the amino acids constituting the synthesized hydrophilic amino acid sequence unit may be modified with other functional groups.

Some of the amino acids constituting peptide possess functional groups rich in reactivity. If such a functional group is used as it is, the functional group reacts with something other than the particular molecule, creating a possibility of losing the particular molecule capturing ability of the peptide. In view of this, such a functional group is preferably modified by another functional group.

In the above configuration, an amino acid at an N terminal of the artificially synthesized peptide may be bonded to the linker.

The amino acid at the N terminal of peptide includes an α-amino group that is not reacted with other functional groups. Bonding this α-amino group to a linker molecule enables the linker to directly bond to the peptide.

In the above configuration, an amino acid at an N terminal of the artificially synthesized peptide may be modified, the amino acid at the N terminal of the artificially synthesized peptide may be an amino acid having primary amine on a side chain, α-amino group of the amino acid at the N terminal may be modified, and the amino acid at the N terminal of the artificially synthesized peptide may be bonded to the linker.

Employing this configuration modifies the α-amino group of the amino acid at the N terminal of the artificially synthesized peptide thereby losing reactivity; however, since the amino acid at the N terminal has primary amine, bonding the primary amine on a side chain of this amino acid to a linker molecule enables the linker to directly bond to the peptide.

As the amino acid having primary amine on a side chain, lysine is preferably used.

Also, for modification of the amino group, an acetyl group is preferably used.

In these configurations, the length of the linker may be from 2.0 to 6.0 nm.

In the case where the linker bonds to the amino acid at the N terminal of the peptide, if the length of the linker is excessively small or large, the particular molecule capturing ability degrades, and in view of this, the above claimed length is preferable. A possible cause of this is that if the length of the linker is excessively small, standing of the peptide is poor, while if the length of the linker is excessively large, the peptide is disposed in such a manner that the tip side of the peptide lies against the support, thereby making it difficult to meet a target molecule.

In the above configuration, an amino group of an amino acid at an N terminal of the artificially synthesized peptide may be modified, an amino acid at a C terminal of the artificially synthesized peptide may be an amino acid having primary amine on a side chain, and the amino acid at the C terminal of the artificially synthesized peptide may be bonded to the linker.

Employing this configuration modifies the amino group of the amino acid at the N terminal of the artificially synthesized peptide thereby losing reactivity; however, since the amino acid at the C terminal has primary amine on a side chain, bonding the primary amine on a side chain of this amino acid to a linker molecule enables the linker to directly bond to the peptide.

As the amino acid having primary amine on a side chain, lysine is preferably used.

In this configuration, the length of the linker may be from 0.5 to 1.5 nm.

When the linker bonds to the amino acid at the C terminal of the peptide, making the length of the linker large degrades the particular molecule capturing ability, though a reason for this is yet to be revealed. Possibly, when the linker bonds to the amino acid at the C terminal of the peptide, making the length of the linker large disposes the peptide in such a manner that the peptide lies against the support, thereby making it difficult to meet a particular molecule.

In the above configuration, an α-amino group of an amino acid at an N terminal of the artificially synthesized peptide may not be modified, an amino acid at a C terminal of the artificially synthesized peptide may be an amino acid having primary amine on a side chain, and the amino acid at the N terminal of the artificially synthesized peptide may be bonded to one linker, and the amino acid at the C terminal of the artificially synthesized peptide may be bonded to another linker.

In this configuration, the amino acid at the N terminal of the peptide and the amino acid at the C terminal of the peptide are bonded to different linkers. Bonding two linkers to the amino acid at the N terminal and the amino acid at the C terminal in this manner disposes the peptide in a manner that makes the peptide easy to meet a particular molecule, thereby increasing the particular molecule capturing ability.

In the above configuration, an amino acid at an N terminal of the artificially synthesized peptide may be an amino acid having primary amine on a side chain, an amino acid at a C terminal of the artificially synthesized peptide may be lysine or arginine, α-amino group of the N terminal may be modified, the amino acid at the N terminal of the artificially synthesized peptide may be bonded to one linker, and the amino acid at the C terminal of the artificially synthesized peptide may be bonded to another linker.

This configuration also disposes the peptide in a manner that makes the peptide easy to meet a particular molecule, thereby increasing the particular molecule capturing ability.

As the amino acid having primary amine on a side chain, lysine is preferably used.

In these configurations, the length of the linker may be from 0.5 to 10 nm.

When the amino acid at the N terminal of the peptide is bonded to one linker and the amino acid at the C terminal of the peptide is bonded to another linker, the particular molecule capturing ability is not influenced by the length of the linker, though a reason for this is yet to be revealed. This is possibly because bonding the linker to the peptide will not dispose the peptide in such a manner that the peptide lies against the support, thereby making it easy to meet a particular molecule. It should be noted, however, that making the length of the linker less than 0.5 nm is technically difficult, while making the length of the linker more than 10 nm results in increased costs. In view of this, restriction within the claimed range is preferable.

In the above configuration, the bonding of the one reactive functional group of the linker to the artificially synthesized peptide may result from a reaction of an epoxy group and an amino group.

In the above configuration, the bonding of the other reactive functional group of the linker to the support may result from a reaction of an epoxy group and an amino group.

With this configuration, the epoxy group and the amino group quickly have a bonding reaction, thereby facilitating the preparation of the biosensor. In order to realize this configuration: as a linker molecule (a molecule that serves as a basis of the linker), a linker molecule having two or more epoxy groups is preferably used; as the peptide, a peptide having α-amino group that is not modified at an N-terminal or a peptide having primary amine on a side chain is preferably used; and as the support, a compound having an amino group on the surface is preferably used.

In the above configuration, the linker may have an alkylene oxide structure represented by “—O—CH₂—CHR—; R denoting a hydrogen atom or an alkyl group.” This is preferable in that a suitable degree of amphiphilicity.

In the above configuration, the artificially synthesized peptide may contain a natural hydrophobic amino acid sequence unit composed of four consecutive hydrophobic amino acids each selected from a group consisting of isoleucine, phenylalanine, valine, leucine, methionine, tryptophan, alanine, glycine, cysteine, and tyrosine, the natural hydrophobic amino acid sequence unit being a sequence of four consecutive amino acids in a hypervariable area of a natural immunoglobulin.

With this configuration, the natural hydrophobic amino acid sequence unit has high recognizability with respect to a particular molecule, thereby improving the particular molecule capturing ability.

In the above configuration, the artificially synthesized peptide may contain a natural hydrophilic amino acid sequence unit composed of four consecutive hydrophilic amino acids each selected from a group consisting of histidine, glutamic acid, asparatic acid, glutamine, asparagine, lysine, arginine, proline, threonine, and serine, the natural hydrophilic amino acid sequence unit being a sequence of four consecutive amino acids in a hypervariable area of a natural immunoglobulin.

With this configuration, the natural hydrophilic amino acid sequence unit has high recognizability with respect to a particular molecule, thereby improving the particular molecule capturing ability.

### EFFECTS OF THE INVENTION

As has been described hereinbefore, a biosensor having high structural stability and excellent molecular recognizability is realized.

### BRIEF DESCRIPTION OF THE DRAWINGS

FIG. 1 is a schematic diagram of a biosensor according to an embodiment.

FIG. 2 is a diagram showing a homology comparison between the amino acid sequence (a Cry-j1 mouse monoclonal antibody IgG (Anti Cry-j1 Mouse #013, available from SEIKAGAKU CORPORATION)) measured in example 1 and an amino acid sequence described in a database.

FIG. 3 is a graph showing light absorbance in the state where fluorescein-TEYTIHWWK serving as an artificially synthesized peptide is immobilized to a chitosan film through Denacole EX-850.

FIG. 4 is a predicted diagram of the structure such that fluorescein-TEYTIHWWK serving as an artificially synthesized peptide is immobilized to chitosan through a linker.

FIG. 5 is a graph showing experimental results in example 1.

FIG. 6 is a graph showing the detection sensitivity of a biosensor according to example 2.

FIG. 7 is a graph showing the detection sensitivity of a biosensor according to example 3.

FIG. 8 is a graph showing the detection sensitivity of a biosensor according to example 4.

FIG. 9 is a schematic view of a biosensor according to example 4.

FIG. 10 is a graph showing the detection sensitivity of a biosensor according to example 5.

### REFERENCE NUMERAL

1 Peptide
2 Support
3 Linker

### BEST MODE FOR CARRYING OUT THE INVENTION

Embodiments of the present invention will be described below.

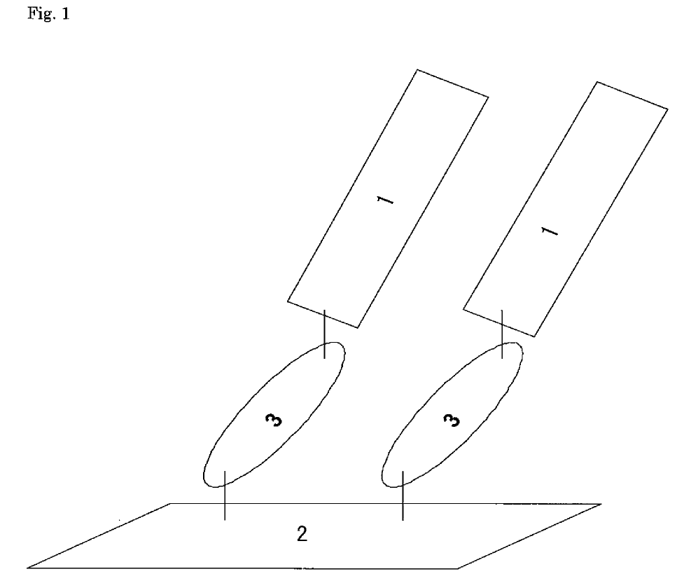

Referring to FIG. 1, a biosensor according to the present invention includes a peptide 1 serving as a molecule recognition substance, a support 2 for holding the peptide, and a linker 3 for linking the peptide 1 and the support 2 to one another.

The peptide according to the present invention is a peptide in which a plurality of amino acids are bonded to each other by peptide bonds, and may be derived from natural substances or artificially synthesized. In view of cost and reproductivity, an artificially synthesized peptide is preferably used. In the case of an artificially synthesized peptide, such a peptide is preferably used that contains, after amino acid sequence analysis of a hypervariable area of an immunoglobulin, three or more consecutive amino acid sequences contained in the hypervariable area.

Here, an amino acid sequence in the hypervariable area of an immunoglobulin is a part that exhibits antigenic specificity most apparently. Therefore, by using a peptide containing three or more consecutive amino acid sequences among the amino acid sequences contained in the hypervariable area of the immunoglobulin, a peptide of high molecule recognizability is realized with a minimum number of amino acids, thereby reducing the cost for artificial synthesis of peptide. In order to further enhance the molecule recognizability, it is preferable to use a peptide containing five or more consecutive amino acid sequences among the amino acid sequences contained in the hypervariable area of the immunoglobulin, and it is more preferable to use a peptide containing eight or more consecutive amino acid sequences among the amino acid sequences contained in the hypervariable area of the immunoglobulin.

The peptide containing three or more consecutive amino acid sequences contained in the hypervariable area of the immunoglobulin may be such that some of the original sequences are changed in order to improve the molecule recognizability and facilitate fixation to the linker. It is possible to add another amino acid to a C terminal and/or an N terminal, or to modify some of the functional groups of the amino acids constituting the peptide.

The number of amino acid sequences in a hypervariable area is generally said to be approximately ten. In order to make an artificially synthesized peptide function as a peptide that carries out molecule recognition, the number of amino acid sequences of the artificially synthesized peptide is such that three or more consecutive amino acid sequences among the amino acid sequences in the hypervariable area are preferably contained, and more preferably five or more consecutive amino acid sequences are contained, and further more preferably eight or more consecutive amino acid sequences are contained.

Also, the number of amino acid sequences of the artificially synthesized peptide is preferably from 3 to 30, and more preferably from 4 to 16. If the number of the amino acid sequences increases, the synthesis cost increases accordingly. Therefore, the number of the amino acid sequences is preferably a minimum number that realizes the molecule capturing function.

Next, description will be made of an example of a modification to the amino acid sequences in the hypervariable area. For example, in the case where an amino acid sequence contains a sequence “isoleucine (I)-histidine (H)-tryptophan (W)-tryptophan (W),” replacing histidine (H) with tryptophan (W) results in four consecutive hydrophobic amino acids, thus improving hydrophobicity. Improvement in hydrophobicity can enhance the particular molecule capturing ability. That is, rather than an artificially synthesized peptide containing entirely identical amino acid sequences to those in a hypervariable area of a natural immunoglobulin, a synthesized peptide in which some of the amino acids are replaced with hydrophobic amino acids possesses high particular molecule capturing ability in many cases.

Also, for example, in the case of a sequence “threonine (T)-glutamic acid (E)-tyrosine (Y)-threonine (T),” replacing tyrosine (Y) with glutamic acid (E) results in four consecutive hydrophilic amino acids, thus improving the hydrophilicity of the peptide. This is believed to enhance the particular molecule capturing ability.

Also, for example, in the case of a sequence “threonine (T)-isoleucine (I)-glutamic acid (E)-tyrosine (Y),” replacing isoleucine (I) with glutamic acid (E) results in four consecutive amino acids forming hydrogen bonds. This is believed to improve the hydrogen bond property of the peptide and further improve the particular molecule capturing ability. The hydrogen-bonding amino acids are serine, threonine, tyrosine, asparatic acid, and glutamic acid.

Also, it is possible to add cysteine to the C terminal and/or N terminal of an amino acid sequence in the hypervariable area in order to provide a bonding property with respect to some other material. Also, by modifying an amino group of an amino acid at the N terminal of an amino acid sequence in the hypervariable area while at the same time adding an amino acid (e.g., lysine) having primary amine on a side chain to the C terminal, the bonding location of the peptide to the linker can be limited to the amino acid at the C terminal. Thus, by the bond between the peptide and the linker, it is made possible to prevent change in the structure of the part of the amino acid sequence carrying out molecule recognition.

Examples of the immunoglobulin include IgG, IgA, IgE, IgM, IgY, and IgD. The IgG antibody, for example, is composed of an H chain and an L chain, and a hypervariable area exists in each of the H chain and the L chain. The hypervariable area to be analyzed may be only the one in the H chain or L chain, or both H chain and L chain may be analyzed.

The immunoglobulin used for analysis is not limited to IgG, and IgA, IgE, IgM, or IgY may be used. It is also possible to use a genetically modified antibody (such as a single-chain antibody) or a phage display.

The method for determining the hypervariable area of the immunoglobulin is the same as the foregoing.

As the method for antibody preparation, a conventionally used method may be used. For example, such a method is used that allergen is injected into a laboratory animal such as a mouse and an antibody protein is produced in the living body, followed by isolation and refinement thereof.

The allergen to generate an antibody is preferably, but not limited to, a substance constituting a whole or part of pollen (in chronological order of report, ragweed, cedar, orchardgrass, Italian ryegrass, Japanese hop, mugwort, rice plant, Quercus serrata, birch, beet, alder, oleander, foxtail, Kentucky 31 Fescue, Typha angustifolia, Philadelphia daisy, strawberry, rose, apple, acacia, yellow sultan, willow, Prunus mume, myrica, pear, cosmos, green pepper, grape, chestnut, umbrella pine, annual bluegrass, cherry, cherry blossom, dianthus, Cape marigold, sheep sorrel, chrysanthemum, pyrethrum, black pine, red pine, Boehmeria nipononivea, zelkova, walnut, dandelion, peach, Tall goldenrod, ginkgo, Alnus sieboldiana, camellia, statice, oilseed rape, gloriosa, mandarin, needle juniper, fennel, olive, yew, fleawort, and podocarpus), house dust (feline-derived substance, roach-derived substance, dog-derived substance, mold-derived substance, mite-derived substance, and mouse-derived substance), or food (Specific raw materials and the like of the Ministry of Health, Labour and Welfare, including wheat, buckwheat, egg, milk, peanut, abalone, squid, salmon roe, shrimp, orange, crab, kiwi fruit, beef, walnut, salmon, mackerel, soybean, chicken meat, pork, matsutake mushroom, peach, yam, apple, and gelatin).

Also, a method to determine the hypervariable area using an mRNA may be employed. The procedure of this method is as follows.

(1) Preparation of an antibody forming cell (hybridoma) by cultivation.

(2) Collection of an mRNA from the cell and refinement of the mRNA.

(3) Synthesis of a cDNA.

(4) Preparation of a library (phage library).

(5) Screening of a target gene.

(6) Hybridization of the target gene (antibody) using a DNA probe.

(7) Cloning of the isolated gene.

(8) Recombination to an Escherichia coli vector.

(9) Gene sequence analysis operation.

(10) Preparation of the vector to which the cloning has been carried out (template DNA for sequence analysis).

(11) PCR operation for gene sequence operation.

(12) Analysis using a DNA sequencer.

(13) Study of the DNA sequencer analysis.

(14) Amino acid sequence analysis of the N terminal of the antibody for confirmation,

(15) Confirmation of agreement between an amino acid sequence based on the studied DNA sequence and the N terminal of the real antibody.

The linker has particular functional groups (reactive functional groups) on both terminals so that the particular functional groups bond the peptide directly to the linker and bond the linker directly to the support. As such a linker, it is preferable to use a hydrocarbon compound having particular functional groups each made of a reaction product of an epoxy group and an amino group. For example, it is possible to use a hydrocarbon compound resulting from reaction of an amino group with a hydrophilic, hydrophobic, or amphiphilic hydrocarbon compound having on both terminals diglycidyl ether with an epoxy group. One epoxy group in the diglycidyl structure has a covalent bond with an amino group that carries out molecule recognition, while the other epoxy group in the diglycidyl structure has a covalent bond with a functional group of the support, so that the peptide is directly bonded to the linker and the linker is directly bonded to the support.

From the viewpoint of water retentability, the linker molecule is preferably poly(or mono)ethylene glycol diglycidyl ether (PEG-DE). The structure of PEG-DE is shown below.

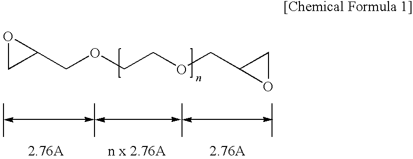

In the formula, the entire chain length of PEG-DE is 8.3 Å in the case of n=1, 11.0 Å in the case of n=2, 16.6 Å in the case of n=4, 30.4 Å in the case of n=9, 41.4 Å in the case of n=13, and 66.2 Å in the case of n=22.

Use of PEG-DE as the linker molecule does not cause curing of the support and the peptide irrespective of the length of PEG while eliminating harmful effects, thereby minimizing the possibility of deactivation of the peptide.

It is known that when the thickness of biological membrane, the thickness of lipid bimolecular membrane of liposome, the thickness of an LB film (monomolecular accumulated film), and the like are 50 Å or less, a linear configuration results, while in the case of a length of approximately 100 Å, the configuration results in a bent state.

To apply this knowledge, when, for example, an artificially synthesized peptide of 34.0 Å (the number of the amino acid sequences is ten) is bonded to a linker of 11.0 Å (n=2), then the sum of the lengths is 45.0 Å, and therefore it is expected that the artificially synthesized peptide and the linker will be linearly arranged. When an artificially synthesized peptide of 7.4 Å (the number of the amino acid sequences is two) is bonded to a linker of 66.2 Å (n=22), then the sum of the lengths is 73.6 Å, and therefore it is expected that the artificially synthesized peptide and the linker will be arranged in a slightly bent state. Further, when an artificially synthesized peptide of 34.0 Å (the number of the amino acid sequences is ten) is bonded to a linker of 66.2 Å (n=22), then the sum of the lengths is 100.2 Å, and therefore it is expected that the artificially synthesized peptide and the linker will be arranged in a bent state.

Here if the length of the linker is too small, the support and the peptide cannot be separated sufficiently, while if the length is too large, the linker bends excessively, creating a possibility of degraded molecule recognition function. In view of this, the length of the linker is preferably from 0.5 to 10 nm (5 to 100 Å), more preferably from 0.8 to 7.0 nm (8 to 70 Å).

The support to immobilize the peptide described in the present invention may be a support that has a functional group reactive to an epoxy group, and as the form of the support itself and the form of a fixing member to fix the support, a substrate, a solid particle, a film, a fiber, a gel, or the like is preferable. As the support having a functional group reactive to an epoxy group, a support having an amino group is preferable for its high reactivity to the epoxy group, and chitosan is particularly preferable for its good handlability. Chitosan can bond to the linker molecule in the form of a particle, a film, a gel, or a solution. Also, a solution of chitosan that has reacted with the peptide through the linker may be immobilized in the form of a film adhered to the surface of another particle, substrate, fiber, or the like.

When chitosan is used as the support and a chitosan thin film is formed on the surface of a substrate or the like, such a method may be employed that chitosan is dissolved in acetic acid or hydrochloric acid, and the substrate or the like is immersed in this solution. On this occasion, the concentration of the chitosan solution is set at approximately 2.5%, and the viscosity thereof is set at 100 to 1000 mPa·s at room temperature, preferably 200 to 500 mPa·s by adjusting the acid concentration.

When a substrate such as a quartz plate, a glass plate, and a silicon plate, or a curved surface such as a fiber and a pipe is immersed in an acid aqueous solution in order to form a thin film on the surface, then the thickness of the film is from 50 to 400 nm. It should be noted, however, that the acid is not limited to the foregoing, and the concentration of the chitosan solution is not limited to 2.5%. Also, the substrate to form the chitosan thin film is not limited to the foregoing, and the film thickness is not limited to the above range.

As the method to immobilize the artificially synthesized peptide to the support through the linker, an immersion method is most convenient. It should be noted, however, that the method for immobilization is not limited to the immersion method.

When the immobilization is carried out by the immersion method, the concentration of the artificially synthesized peptide contained in the immersion solution is preferably from 0.001 to 2.0 mole/L, more preferably from 0.005 to 1.0 mole/L. The concentration of the linker molecule contained in the immersion solution is preferably from 0.001 to 4.0 mole/L, more preferably from 0.008 to 2.0 mole/L.

In the configuration where the artificially synthesized peptide is immobilized to the support through the linker, the artificial peptide immobilized to the support may be of a single kind, or two or more kinds existing in a random manner. It is also possible to form on the support a molecule recognition area A where a plurality of peptides of a single kind are immobilized, and a molecule recognition area B where a plurality of peptides of a single kind different from the foregoing are immobilized. It is also possible to form three or more molecule recognition areas, or to immobilize a plurality of kinds of peptides in one molecule recognition area.

To this biosensor, all the known detection methods are applicable including optical detection methods, electrochemical detection methods, and mechanical detection methods. Description will be made of an example of using an optical detection method employing an enzyme immunoassay quantitation method (ELISA method).

[Detection Method 1]

(Preparation of a Biosensor)

Into a well of an ELISA-dedicated plate having a chitosan thin film formed on the surface, a mixture solution of linker molecules each having an epoxy group on both terminals and artificially synthesized peptides is dropped, and the resulting product is left to stand for several hours to several days at any temperature between 4 and 40° C., thus preparing a biosensor.

(Blocking Treatment)

Then, the mixture solution of the linker molecules and the peptides is washed with a buffer solution or the like, followed by addition of a blocking solution (e.g., BSA (bovine serum albumin) solution). The resulting product is left to stand for several hours to several days at any temperature between 4 and 40° C., followed by blocking treatment. After the blocking treatment, the well is washed with a phosphoric acid buffer solution containing a surface active agent.

(Peptide-Allergen Composite Formation Reaction)

Next, a phosphoric acid buffer solution containing allergen protein and BSA is dropped into the well at concentrations of 0, 1, 5, and 10 ng/mL to cause a reaction for 2 hours at room temperature. Then, the well is washed by the same method as the foregoing.

(Peptide-Allergen-Enzyme Labeled Antibody Composite Formation Reaction)

To a well of an ELISA-dedicated plate on which an artificially synthesized peptide is solidified, a phosphoric acid buffer solution containing a peroxidase-bonded monoclonal antibody and BSA is added, and the resulting product is left to stand for one hour at 37° C. Then, the well is washed with a phosphoric acid buffer solution containing a surface active agent.

(Enzyme Reaction)

Next, a substrate that develops color by reacting with an enzyme is added to the well, and the substrate and the peroxidase are allowed to react with one another for 10 minutes at room temperature. Then, an enzyme reaction discontinuation solution is added to the resulting product.

(Detection)

A 450 nm light absorbance is measured with a plate reader.

As another optical detection, the following method is exemplified. It should be noted that the steps between the preparation of the biosensor and the peptide-allergen composite formation reaction are the same as those in detection method 1 except that the artificially synthesized peptide contains cysteine, and therefore description of the steps will be omitted.

[Detection Method 2]

(Peptide-Allergen-Fluorescent Labeling Antibody Composite Formation Reaction)

To a well of an ELISA-dedicated plate on which an artificially synthesized peptide is solidified, a phosphoric acid buffer solution containing a fluorescent dye-labeled monoclonal antibody and BSA is added, and the resulting product is left to stand for one hour at 37° C. Then, the well is washed with a phosphoric acid buffer solution containing a surface active agent.

(First Detection)

First, a 450 nm light absorbance is measured with a plate reader.

(Second Detection)

Gold colloid is added, and after standing and washing, a 450 nm light absorbance is measured again with a plate reader.

Generally, allergen protein is adsorbed by non-specific adsorption to a plate portion other than peptide, and a color development resulting from this is detected as a noise. However, when this method is used, the gold colloid bonds to cysteine of the peptide prior to the allergen protein, so that the allergen protein leaves the peptide-allergen protein composite. Thus, the light absorbance detected in the second detection is a light absorbance derived from the non-specific adsorption. Thus, by obtaining a difference between the first detection and the second detection, the amount of an actual recognition reaction can be measured.

As another optical detection, the following method is preferably carried out, but will not be provided by way of limitation. It should be noted that the steps between the preparation of the biosensor and the peptide-allergen composite formation reaction are the same as those in detection method 1, and therefore description of the steps will be omitted.

[Detection Method 3]

(Peptide-Allergen-Cysteine Containing Peptide Composite Formation Reaction)

To a well of an ELISA-dedicated plate on which an artificially synthesized peptide is solidified, a phosphoric acid buffer solution containing a cysteine-containing peptide is added, and the resulting product is left to stand for one hour at 37° C. Then, the well is washed with a phosphoric acid buffer solution containing a surface active agent.

(Enzyme Reaction)

Next, gold colloid is added to the well, and the gold colloid and the cysteine are allowed to react to one another for 10 minutes at room temperature.

(Detection)

A red-color development resulting from the gold colloid is measured.

As a mechanical detection, the following method is preferably carried out, but will not be provided by way of limitation.

[Detection Method 4]

An existing silicon wafer is processed into the form of a strip. A strip of two stage structure composed of a tip portion of 1 mm wide and 3 mm long and a base portion of 5 mm wide and 10 mm long is prepared. A piezo element is connected at a boundary portion of the tip portion and the base portion, and the other side of the base portion is fixed to a SUS 304 jig.

On the tip portion, a chitosan thin film is formed, and an artificially synthesized peptide is immobilized to the chitosan in the same manner as in detection method 1.

A resonance frequency of 420 kHz is given to the piezo element. When the artificially synthesized peptide bonds to the allergen protein, the resonance frequency changes. Converting this frequency change into a substrate specificity reaction weight enables the amount of the allergen protein to be detected.

As an electrochemical detection, the following method is preferably carried out, but will not be provided by way of limitation.

[Detection Method 5]

A plastic substrate of 5 mm by 3 mm is provided with a gold electrode or platinum electrode of 5 mm by 1 mm on both sides of the plastic substrate. A lead is attached to each of these electrodes, and further, a chitosan thin film is formed over the plastic substrate. An artificially synthesized peptide is immobilized to the chitosan in the same manner as in detection method 1.

To the electrodes on both sides of the plastic substrate, an AC current of from 1 Hz to 1 MHz is optionally applied, and when the artificially synthesized peptide bonds to the allergen protein, an AC impedance changes. With the amount of change in the AC impedance, the amount of the allergen protein can be detected.

### Example 1

### Analysis of the Hypervariable Area of Pollen Allergen Cry-J1

An antibody to recognize Cry-J1 derived from Japanese cedar (Cryptomeria japonica) is an IgG antibody, and a hypervariable area of an H chain of the IgG antibody was analyzed. As this IgG antibody, a mouse monoclonal antibody (Anti Cryj1 Mouse #013, available from SEIKAGAKU CORPORATION) was used.

(1) First, in order to determine from the material an antibody sample to which an amino acid sequencing (the Edman method) is carried out, the following experiment was carried out.

Generally, the amino acid sequencing is one by which analysis is carried out starting from the N terminal. Some proteins, however, have an N terminal amino acid blocked (modified), and if the N terminal amino acid is blocked, the amino acid sequencing cannot be carried out in some cases. In view of this, in order to select a sample without blockage from a plurality of antibody samples, the following experiment was carried out.

(2) The amino acid sequencing of the hypervariable area of the IgG antibody were analyzed by HPLC. When the amino acid sequencing was carried out for several residues (six in this embodiment), an amino acid that is contained as an impurity is detected at the same time in addition to amino acids of the H chain and L chain. In view of this, the detected amino acids were classified into constituents of the H chain, constituents of the L chain, and impurities.

(3) Here, since antibodies derived from the same kind (same living thing) have the same basic structures, all H chain amino acid sequences of a known mouse monoclonal were picked up from a gene database (sequences translated from gene information on GenBank (http://www.genome.jp/dbget-bin/www#bfind?genbank-today)), and were subjected to a homology comparison with respect to an amino acid sequence related to a target antibody kind (sub-type). Here, when there is an amino acid sequence that agrees to an amino acid analyzed in (2), this antibody has an H chain without blockage. The same was carried out for the L chain to determine the presence or absence of blockage. In this manner, an amino acid sequence without blockage was selected, and an antibody sample to which the amino acid sequencing was carried out was determined.

(4) Using the antibody sample determined in (3), an amino acid sequencing was carried out.

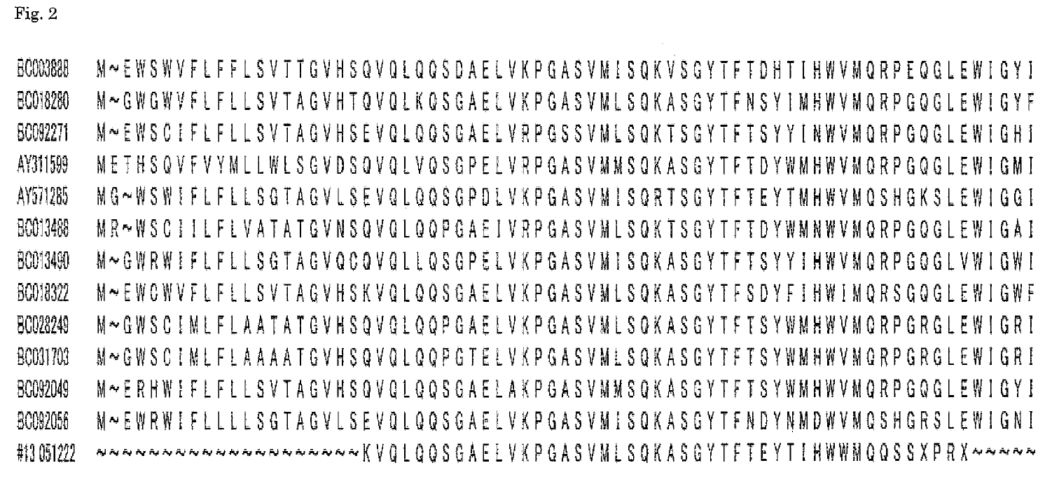

(5) All H chain amino acid sequences of a known antibody were picked up and subjected to a homology comparison with respect to an amino acid sequence related to a target antibody kind (sub-type). A sequence part area that corresponded to a hypervariable area of the known antibody (generally, approximately 20th to 40th, 50th to 70th, or 80th to 120th amino acids counted from the N terminal of the H chain and L chain of an immunoglobulin molecule) and that was unique to the amino acid sequence analyzed in (4) was determined as a #013 hypervariable area. The result of the analysis is shown in FIG. 2. In the figure, the symbol “˜” denotes a gap (insertion, deletion) in the sequences of the amino acid sequences subjected to the homology comparison for the purpose of making agree (alignment) the sequence locations of homologous amino acids.

As a result, the amino acid sequence of the H chain hypervariable area of the Cry-J1 mouse monoclonal antibody IgG (Anti Cry-J1 Mouse #013, available from SEIKAGAKU CORPORATION) derived from Japanese cedar (Cryptomeria japonica) was determined as TEYTIHWW, from the N terminal to the C terminal.

[Artificial Synthesis of Cry-J1 Recognition Peptide]

The following two peptides were artificially synthesized on a usual peptide artificial synthesis apparatus.

(1) Fluorescein-bonded TEYTIHWWK (fluorescein was bonded to T).

(2) Acetylated TEYTIHWWK (only an α-amino group of T at the N terminal was acetylated).

In order to limit the bonding of the peptide and the linker to an amino acid at the C terminal of the peptide in each of the above amino acid sequences, lysine (K) was added to the C terminal of the amino acid sequence of the hypervariable area and an amino group of the amino acid at the N terminal was modified, thereby eliminating reactivity.

[Immobilization of Synthesized Peptide on Chitosan Thin Film and Structure Speculation]

Using the fluorescein-TEYTIHWWK, a synthesized peptide was immobilized on a chitosan thin film.

A 10 mL aqueous acetic acid solution of 2.5% chitosan (CTF available from Katakura Chikkarin Co., Ltd.) was prepared. 2 mL of this was separated with a syringe and dropped onto a quartz plate of 25 mm×25 mm. This quartz plate was rotated for 30 seconds at 3000 rpm and then dried for one hour at 80° C. A chitosan film prepared by this spin cast method was a film with a uniform thickness of 200 nm.

Next, a 10 mL aqueous solution in which 0.34 mmol fluorescein-TEYTIHWWK and 0.34 mmol polyethylene diglycidyl ether (Denacole EX-850, available from Nagase ChemteX Corporation) were dissolved was prepared, and the quartz plate coated with the chitosan film was immersed in this solution. The immersion time was 18 hours. Drying of the quartz plate coated with the chitosan film was carried out in a clean bench for 24 hours. Then, the quartz plate coated with the chitosan film was immersed in distilled water for 24 hours to wash the plate. Drying of the plate after the washing was carried out in a clean bench for 24 hours.

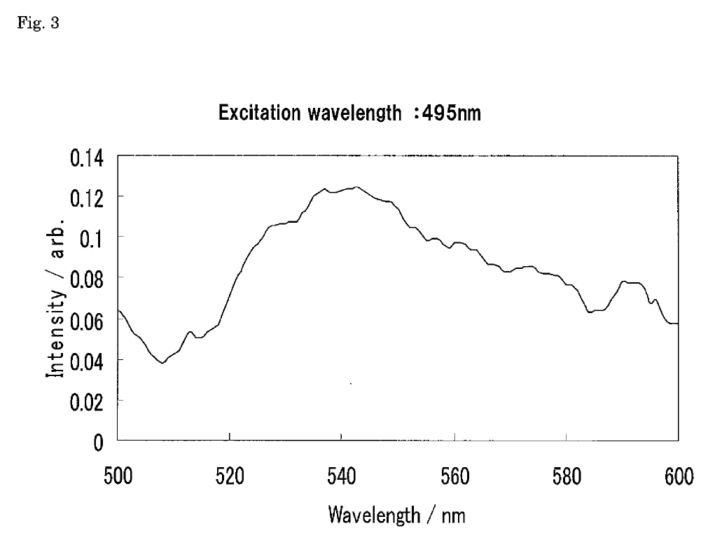

This quartz plate was irradiated with light of 495 nm excitation wavelength to detect fluorescence. The results are shown in FIG. 3. As seen from FIG. 3, emission of 540 nm light was observed. Thus, it was confirmed that the above-described operation immobilized the fluorescein-TEYTIHWWK to the chitosan film through linkers.

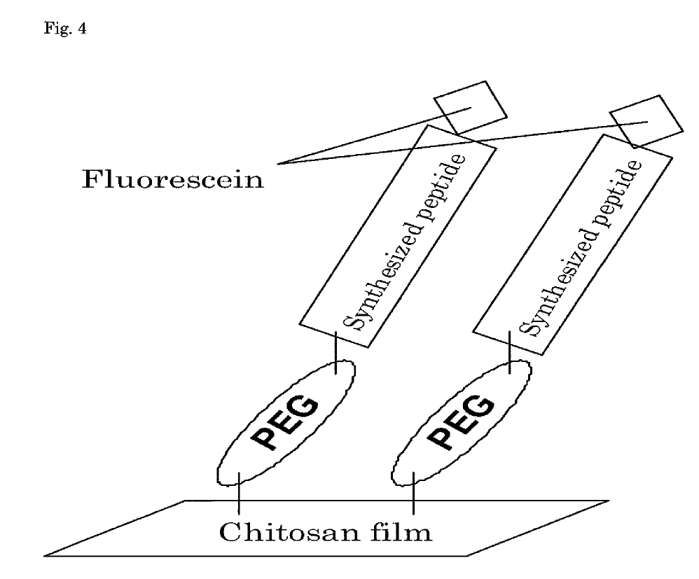

As a speculation as to the chain structure of the fluorescein-TEYTIHWWK bonded to Denacole EX-850 serving as a linker molecule, the structure is immobilized in such a state that the structure stands up on the plane of the chitosan film, in view of the length of the chain. A speculated view is shown in FIG. 4.

[Preparation and Detection of the Biosensor]

The reactivity between anti-Cry-J1 antibody H chain hypervariable area peptide (acetylated TEYTIHWWK) and pollen allergen protein (Cry-J1) was studied by the ELISA method. The experiment method can be summarized as follows.

(1) Immobilization of Peptide

To a well of an amino group-bonded plate (MS-3608F, available from SUMITOMO BAKELITE Co., Ltd.), a 200 μL solution of 0.0095 mg/mL acetylated TEYTIHWWK and 0.018 mg/mL polyethylene diglycidyl ether was added, and the resulting product was settled for a night at 4° C.

(2) Blocking Processing

The peptide solution was taken out, followed by addition thereto 200 μL Blocking One (available from Nacalai Tesque, Inc.), and the resulting product was subjected to blocking processing.

(3) Washing of the Well

After the blocking processing, the blocking solution was taken out and the well was washed with PBS containing 0.05% Tween 20. As the washing, the operation of adding and taking out 200 μL PBS containing 0.05% Tween 20 (20 mM of sodium phosphate, pH 7.4, 0.15 M of NaCl) to and of the well was carried out three times.

(4) Addition of Pollen Allergen Cry-J1

Pollen allergen Cry-J1 (available from SEIKAGAKU CORPORATION) was diluted to 0, 1, 5, and 10 ng/mL with the use of PBS containing 0.1% BSA and added to the well on a 100 μL basis. After the addition, the resulting product was left to stand for 2 hours at room temperature.

(5) Washing of the Well

The Cry-J1 solution was taken out and the well was washed in the same manner as (3).

(6) Addition of Peroxidase-bonded Anti-Cry-J1 Monoclonal Antibody

A solution in which peroxidase-bonded anti-Cry-J1 monoclonal antibody (available from SEIKAGAKU CORPORATION) was diluted 1000-fold with 0.1% PBS containing BSA was added to the well on a 100 μL basis. The resulting product was left to stand for one hour at 37° C.

(7) Washing of the Well

The peroxidase-bonded anti-Cry-J1 monoclonal antibody solution was taken out and the well was washed in the same manner as (3).

(8) Color Development

To the well, 100 μL color developing solution (available from Nacalai Tesque, Inc.) was added to cause a reaction for 10 minutes at room temperature. After the 10 minutes of reaction, 100 μL stop solution was added, and a 450 nm light absorbance was measured with a plate reader (available from Bio-Rad Laboratories, Inc.).

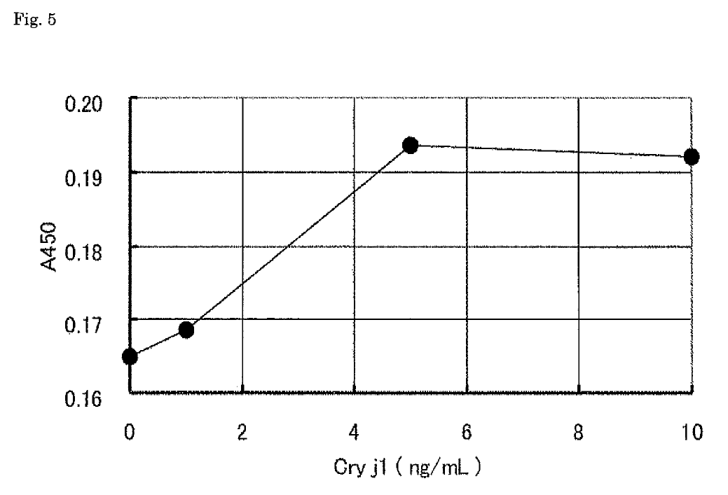

The results are shown in FIG. 5. That is, it has been found that the pollen allergen protein (Cry-J1) is captured by the peptide depending on the concentration of the protein and thus can be detected.

### Example 2

In order to examine influences that the length of the linker has on the detection sensitivity of the biosensor, the following experiment was carried out. A 5 μg/mL aqueous solution of acetyl-NH-TEYTIHWWK-COOH(SH1) serving as an artificially synthesized CRY-J1 recognition peptide was mixed with a sodium hydrogen carbonate buffer solution (pH=9) containing 45 μM poly(or mono)ethylene glycol diglycidyl ether (PEG-DG) in order to cause a solid phase reaction.

As PEG-DG (poly(or mono)ethylene glycol diglycidyl ether) serving as a linker molecule, six kinds thereof with different chain lengths were selected. Specifically, sample 1: 8.3 Å chain length, degree of polymerization n=1; sample 2: 11.0 Å chain length, degree of polymerization n=2; sample 3: 16.6 Å chain length, degree of polymerization n=4; sample 4: 80.4 Å chain length, degree of polymerization n=9; sample 5: 41.4 Å chain length, degree of polymerization n=13; and sample 6: 66.2 Å chain length, degree of polymerization n=22. The PEG-DG was selected from the Denacole EX series of Nagase ChemteX Corporation.

Using an aminated 96-hole ELISA method plate (Sumilon MS-3608F, available from SUMITOMO BAKELITE Co., Ltd.) as a solid phase, the solid phase reaction was completed in 24 hours at room temperature.

Next, each of the 96 holes of the ELISA method plate was filled with 100 μL distilled water three times in order to carry out washing.

Blocking One, available from Nacalai Tesque, Inc., was used for the blocking, and the reaction was carried out at room temperature and completed in 24 hours.

An excessive blocking agent was rinsed three times with the use of a phosphoric acid buffer solution (pH=7) containing 0.1% Tween 25 surface active agent.

The acetyl-NH-TEYTIHWWK-COOH was diluted with distilled water, and those having concentrations of 0 μg/mL, 0.2 μg/mL, 0.5 μg/mL, 1.0 μg/mL, 2.0 μg/mL, and 5.0 μg/mL were prepared.

To each of the linker molecules with different lengths, 50 μL of each of the acetyl-NH-TEYTIHWWK-COOH diluted solutions of 0 μg/mL, 0.2 μg/mL, 0.5 μg/mL, 1.0 μg/mL, 2.0 μg/mL, and 5.0 μg/mL was dropped to cause bonding between the linker and the peptide.

Acetyl-NH-TEYTIHWWK-COOH that did not react with the linker was rinsed three times with a phosphoric acid buffer solution (pH=7) containing 0.1% Tween. 25 surface active agent.

Anti-cedar pollen antigen Cry-J1-HRP (Horse Radish Peroxidase) (SEIKAGAKU CORPORATION) serving as a secondary antibody was prepared by diluting it 1000-fold with a phosphoric acid buffer solution containing 0.1% Tween 20, and 100 μL of this preparation solution was added to cause a reaction for one hour at room temperature.

Secondary antibodies (anti-cedar pollen antigen Cry-J1-HRP) that did not react were rinse three times with the use of a phosphoric acid buffer solution (pH=7) containing 0.1% Tween 25 surface active agent.

The coloring reaction was carried out at room temperature with the use of ELISA POD Substrate TMB Kit (available from Nacalai Tesque, Inc.) serving as a color developing solution. Thirty minutes after 100 μL substrate solution was added, 100 L post-reaction stop solution was added and a 450 nm light absorbance was measured.

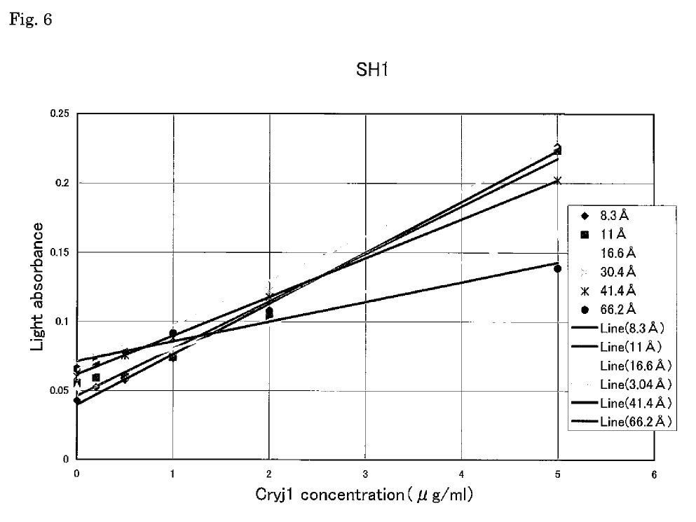

FIG. 6 shows a graph of poly(or mono)ethylene glycol diglycidyl ether (PEG-DG) linker length (Angstrom unit) on the horizontal axis and light absorbance on the vertical axis, thus denoting the inclination as detection efficiency.

For the six kinds of poly(or mono)ethylene glycol diglycidyl ether (PEG-DG) with different lengths, namely, (1) 8.3 Å chain length, degree of polymerization n=1; (2) 11.0 Å chain length, degree of polymerization n=2; (3) 16.6 Å chain length, degree of polymerization n=4; (4) 30.4 Å chain length, degree of polymerization n=9; (5) 41.4 Å chain length, degree of polymerization n=13; and (6) 66.2 Å chain length, degree of polymerization n=22, the inclination of the 450 nm light absorbance was linear in all the cases of antigen Cryj1 concentrations of 0 μg/mL, 0.2 μg/mL, 0.5 μg/mL, 1.0 μg/mL, and 2.0 μg/mL.

As seen from FIG. 6, it has been found that the detection efficiencies with respect to Cry-J1 in the cases where acetyl-NH-TEYTIHWWK-COOH serving as the artificially synthesized peptides were bonded to linker lengths of 15 Å or less (degree of polymerization n=1 or 2) were higher than the detection efficiencies in the cases where the artificially synthesized peptides were bonded to linker lengths of 16.6 Å or more (degree of polymerization n=4 or greater). A possible reason for this is that with a short linker, the amino acid sequence of the peptide exists in a relatively upright manner, which is a state that facilitates association with Cry-J1, while as the linker becomes longer, the peptide is disposed as if to lie against the substrate, which makes association with Cry-J1 difficult.

Thus, it can be seen that when a linker is bonded to the amino acid at the C terminal of the artificially synthesized peptide, the linker length is preferably 1.5 nm (15 Å) or less.

### Example 3

Contrary to example 2, an examination was carried out as to influences that the length of the linker has on the detection sensitivity in the case of bonding the linker to the N terminal of the peptide. For this purpose, acetyl-NH-KTEYTIHWW-COOH(SH2) was synthesized. The acetylation was carried out only to an α-amino group of lysine (K), and an amino group on a side chain of lysine was bonded to the linker.

The solid phase reaction was caused by mixing a 5 μg/mL aqueous solution of acetyl-NH-KTEYTIHWW-COOH serving as an anti-Cry-J1 antibody H chain hypervariable area peptide with a sodium hydrogen carbonate buffer solution (pH=9) containing 45 μM poly(or mono)ethylene glycol diglycidyl ether (PEG-DM

As poly(or mono)ethylene glycol diglycidyl ether (PEG-DG), six kinds thereof with different chain lengths were selected. Specifically, (1) 8.3 Å chain length, degree of polymerization n=1; (2) 11.0 Å chain length, degree of polymerization n=2; (3) 16.6 Å chain length, degree of polymerization n=4; (4) 30.4 Å chain length, degree of polymerization n=9; (5) 41.4 Å chain length, degree of polymerization n=13; and (6) 66.2 Å chain length, degree of polymerization n=22. The PEG-DG was selected from the Denacole EX series of Nagase ChemteX Corporation.

Using an aminated 96-hole ELISA method plate (Sumilon MS3608F, available from SUMITOMO BAKELITE Co., Ltd.) as a solid phase, the solid phase reaction was completed in 24 hours at room temperature.

Next, each of the 96 holes of the ELISA method plate was filled with 100 μL distilled water three times in order to carry out washing.

Blocking One, available from Nacalai Tesque, Inc., was used for the blocking, and the reaction was carried out at room temperature (25° C.) and completed in 24 hours.

An excessive blocking agent was rinsed three times with the use of a phosphoric acid buffer solution (pH=7) containing 0.1% Tween 25 surface active agent.

The acetyl-NH-KTEYTIHWW-COOH was diluted with distilled water, and those having concentrations of 0 μg/mL, 0.2 μg/mL, 0.5 μg/mL, 1.0 μg/mL, 2.0 μg/mL, and 5.0 μg/mL were prepared.

To each of the linker molecules with different lengths, 50 μL of each of the acetyl-NH-KTEYTIHWW-COOH diluted solutions of 0 μg/mL, 0.2 μg/mL, 0.5 μg/mL, 1.0 μg/mL, 2.0 μg/mL, and 5.0 μg/mL was dropped.

Acetyl-NH-KTEYTIHWW-COOH that was not reactive was rinsed three times with a phosphoric acid buffer solution (pH=7) containing 0.1% Tween 25 surface active agent.

Anti-cedar pollen antigen Cry-J1-HRP (SEIKAGAKU CORPORATION) serving as a secondary antibody was prepared by diluting it 1000-fold with a phosphoric acid buffer solution containing 0.1% Tween 20, and 100 μL of this preparation solution was added to cause a reaction for one hour at room temperature.

Secondary antibodies (anti-cedar pollen antigen Cry-J1-HRP) that did not react were rinse three times with the use of a phosphoric acid buffer solution (pH=7) containing 0.1% Tween 25 surface active agent.

The coloring reaction was carried out at room temperature with the use of ELISA POD Substrate TMB Kit (available from Nacalai Tesque, Inc.) serving as a color developing solution. Thirty minutes after 100 μL substrate solution was added, 100 μL post-reaction stop solution was added and a 450 nm light absorbance was measured.

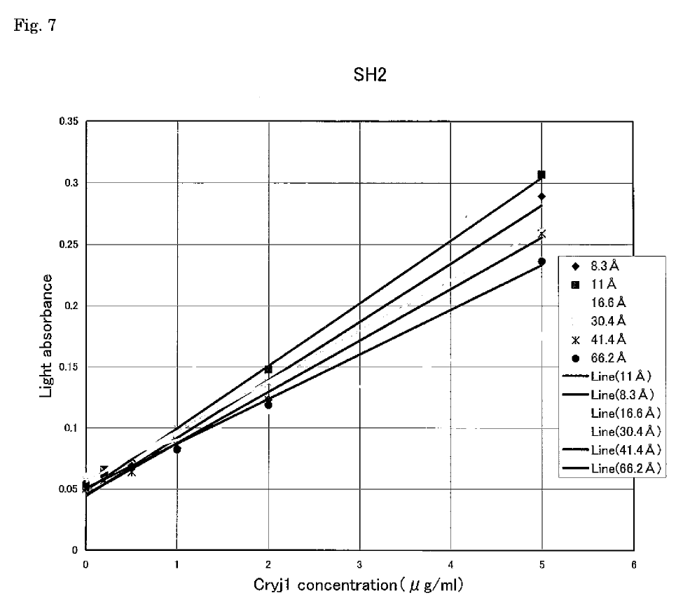

FIG. 7 shows a graph of poly(or mono)ethylene glycol diglycidyl ether (PEG-DG) linker length (Angstrom unit) on the horizontal axis and light absorbance on the vertical axis, thus denoting the inclination as detection efficiency.

For the six kinds of poly(or mono)ethylene glycol diglycidyl ether (PEG-DG) with different lengths, namely, (1) 8.3 Å chain length, degree of polymerization n=1; (2) 11.0 Å chain length, degree of polymerization n=2; (3) 16.6 Å chain length, degree of polymerization n=4; (4) 30.4 Å chain length, degree of polymerization n=9; (5) 41.4 Å chain length, degree of polymerization n=13; and (6) 66.2 Å chain length, degree of polymerization n=22, the inclination of the 450 nm light absorbance was linear in all the cases of antigen Cryj1 concentrations of 0 μg/mL, 0.2 μg/mL, 0.5 μg/mL, 1.0 μg/mL, and 2.0 μg/mL.

Also, as seen from FIG. 7, it has been found that in the cases of linker lengths of 20 to 60 Å (2.0 to 6.0 nm, degree of polymerization n=4 to 9), the detection efficiencies with respect to Cry-J1 of acetyl-NH-KTEYTIHWW-COOH serving as the artificially synthesized peptides were high. A possible reason for this, though not clearly revealed, is that when the length of the linker is within a predetermined range, the amino acid sequence of the peptide exists in a relatively upright manner, which is a state that facilitates capture of Cry-J1.

### Example 4

In this example, an examination was carried out as to influences that linker length has on the detection sensitivity in the case of bonding one linker to the N terminal of the artificially synthesized peptide and another linker to the amino acid at the C terminal of the artificially synthesized peptide.

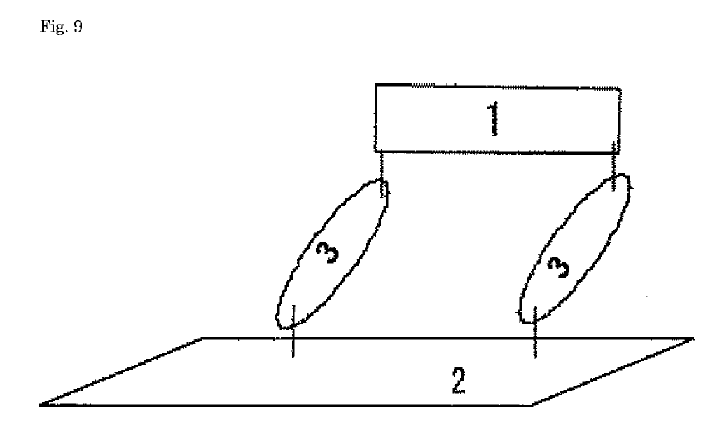

Acety-NH-KTEYTIHWWK-COOH(SH3) was synthesized. Specifically, a lysine residue was located at both terminals of the amino acid sequence of the Cry-J1 recognition peptide such that an amino group on a side of chain of the C terminal lysine is bonded to one linker, while an α-amino group of the N terminal lysine is acetylated and an amino group on a side chain of the N terminal lysine is bonded to the other linker. FIG. 9 shows a schematic view of this.

The solid phase reaction was caused by mixing a 5 μg/mL aqueous solution of acetyl-NH-KTEYTIHWWK-COOH with a sodium hydrogen carbonate buffer solution (pH=9) containing 45 μM poly(or mono)ethylene glycol diglycidyl ether (PEG-DG).

As poly(or mono)ethylene glycol diglycidyl ether (PEG-DG), six kinds thereof with different chain lengths were selected. Specifically, (1) 8.3 Å chain length, degree of polymerization n=1; (2) 11.0 Å chain length, degree of polymerization n=2; (3) 16.6 Å chain length, degree of polymerization n=4; (4) 30.4 Å chain length, degree of polymerization n=9; (5) 41.4 Å chain length, degree of polymerization n=13; and (6) 66.2 Å chain length, degree of polymerization n=22. The PEG-DG was selected from the Denacole EX series of Nagase ChemteX Corporation.

Using an aminated 96-hole ELISA method plate (Sumilon MS-3608F, available from SUMITOMO BAKELITE Co., Ltd.) as a solid phase, the solid phase reaction was completed in 24 hours at room temperature.

Next, each of the 96 holes of the ELISA method plate was filled with 100 μL distilled water three times in order to carry out washing.

Blocking One, available from Nacalai Tesque, Inc., was used for the blocking, and the reaction was carried out at room temperature (25° C.) and completed in 24 hours.

An excessive blocking agent was rinsed three times with the use of a phosphoric acid buffer solution (pH=7) containing 0.1% Tween 25 surface active agent.

The acetyl-NH-KTEYTIHWWK-COOH was diluted with distilled water, and those having concentrations of 0 μg/mL, 0.2 μg/mL, 0.5 μg/mL, 1.0 μg/mL, 2.0 μg/mL, and 5.0 μg/mL were prepared.

To each of the linker molecules with different lengths, 50 μL of each of the acetyl-NH-KTEYTIHWWK-COOH diluted solutions of 0 μg/mL, 0.2 μg/mL, 0.5 μg/mL, 1.0 μg/mL, 2.0 μg/mL, and 5.0 μg/mL was dropped.

Antigen Cry-J1 that was not reactive was rinsed three times with a phosphoric acid buffer solution (pH=7) containing 0.1% Tween 25 surface active agent.

Anti-cedar pollen antigen Cry-J1-HRP (SEIKAGAKU CORPORATION) serving as a secondary antibody was prepared by diluting it 1000-fold with a phosphoric acid buffer solution containing 0.1% Tween 20, and 100 μL of this preparation solution was added to cause a reaction for one hour at room temperature.

Secondary antibodies (anti-cedar pollen antigen Cry-J1-HRP) that did not react were rinse three times with the use of a phosphoric acid buffer solution (pH=7) containing 0.1% Tween 25 surface active agent.

The coloring reaction was carried out at room temperature with the use of ELISA POD Substrate TMB Kit (available from Nacalai Tesque, Inc.) serving as a color developing solution. Thirty minutes after 100 μL substrate solution was added, 100 μL post-reaction stop solution was added and a 450 nm light absorbance was measured.

For the six kinds of poly(or mono)ethylene glycol diglycidyl ether (PEG-DG) with different lengths, namely, (1) 8.3 Å chain length, degree of polymerization n=1; (2) 11.0 Å chain length, degree of polymerization n=2; (3) 16.6 Å chain length, degree of polymerization n=4; (4) 30.4 Å chain length, degree of polymerization n=9; (5) 41.4 Å chain length, degree of polymerization n=13; and (6) 66.2 Å chain length, degree of polymerization n=22, the inclination of the 450 nm light absorbance was linear in all the cases of antigen Cryj1 concentrations of 0 μg/mL, 0.2 μg/mL, 0.5 μg/mL, 1.0 μg/mL, and 2.0 μg/mL.

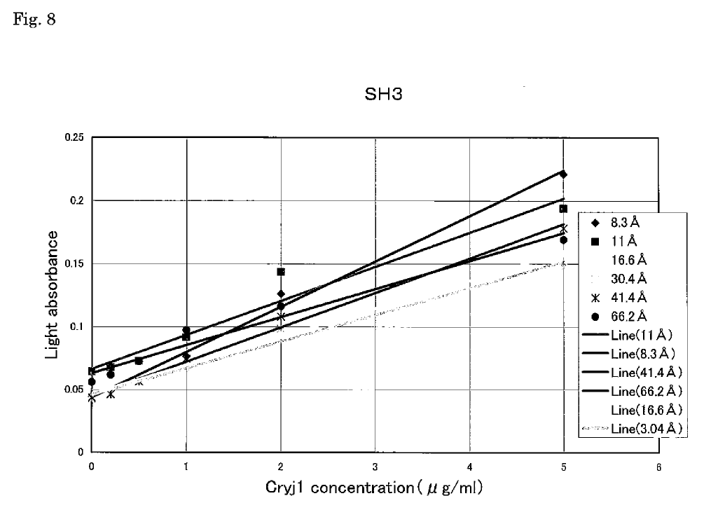

FIG. 8 shows a graph of poly(or mono)ethylene glycol diglycidyl ether (PEG-DG) linker length (Angstrom unit) on the horizontal axis and light absorbance on the vertical axis, thus denoting the inclination as detection efficiency.

As seen from FIG. 8, it has been found that the detection efficiencies with respect to Cry-J1 of acetyl-NH-KTEYTIHWWK-COOH were substantially the same irrespective of the linker length. A possible reason for this is that when one linker is bonded to the N terminal of the artificially synthesized peptide and the other is bonded linker to the amino acid at the C terminal of the artificially synthesized peptide, the artificially synthesized peptide is located in parallel to the substrate instead of being influenced by the linker length, thereby making Cryj-1 captured by the artificially synthesized peptide (SH3) in substantially the same manner.

### Example 5

For the amino acid sequence of NH-TEYTIHWW-COOH, which is the amino acid sequence of the hypervariable area of anti-Cryj-1 immunoglobulin, hydrophilicity is dominant in the sequence TEYT, as seen from the N terminal side, in that T, E, and T are hydrophilic. In IHWW, hydrophobicity is dominant in that I and W are hydrophobic. Also, tryptophan (W) is believed to function as a recognition site of peptide and protein in many cases. In view of this, in order to increase the hydrophilicity of the sequence TEYT close to the N terminal and increase the hydrophobicity of the sequence IHWW close to the C terminal, tyrosine (Y) was changed to hydrophilic glutamic acid and histidine (H) was changed to hydrophobic tryptophan (W), thus artificially synthesizing acetyl-NH-TEETIWWWK-COOH (AL1).

The solid phase reaction was caused by mixing a 5 μg/mL aqueous solution of acetyl-NH-TEETIWWWK-COOH with a sodium hydrogen carbonate buffer solution (pH=9) containing 45 μM polyethylene glycol diglycidyl ether (PEG-DG).

As polyethylene glycol diglycidyl ether (PEG-DG), one such that the chain length was 11.0 Å and the degree of polymerization was n=2 was used.

Using an aminated 96-hole ELISA method plate (Sumilon MS-3608F, available from SUMITOMO BAKELITE Co., Ltd.) as a solid phase, the solid phase reaction was completed in 24 hours at room temperature.

Next, each of the 96 holes of the ELISA method plate was filled with 100 μL distilled water three times in order to carry out washing.

Blocking One, available from Nacalai Tesque, Inc., was used for the blocking, and the reaction was carried out at room temperature (25° C.) and completed in 24 hours.

An excessive blocking agent was rinsed three times with the use of a phosphoric acid buffer solution (pH=7) containing 0.1% Tween 25 surface active agent.

The artificially synthesized peptide AL1 was diluted with distilled water, and those having concentrations of 0 μg/mL, 0.2 μg/mL, 0.5 μg/mL, 1.0 μg/mL, 2.0 μg/mL, and 5.0 μg/mL were prepared.

The reaction of the artificially synthesized peptide AM was carried out in such a manner that 50 μL of each of the antigen Cryj1 diluted solutions of 0 μg/mL, 0.2 μg/mL, 0.5 μg/mL, 1.0 μg/mL, 2.0 μg/mL, and 5.0 μg/mL was dropped to cause bonding between the linker and the peptide.

Artificially synthesized peptide AL1 that was not reactive was rinsed three times with a phosphoric acid buffer solution (pH:=7) containing 0.1% Tween 25 surface active agent.

Anti-cedar pollen antigen Cry-J1-HRP (SEIKAGAKU CORPORATION) serving as a secondary antibody was prepared by diluting it 1000-fold with a phosphoric acid buffer solution containing 0.1% Tween 20, and 100 μL of this preparation solution was added to cause a reaction for one hour at room temperature.

Secondary antibodies (anti-cedar pollen antigen Cry-J1-HRP) that did not react were rinse three times with the use of a phosphoric acid buffer solution (pH=7) containing 0.1% Tween 25 surface active agent.

The coloring reaction was carried out at room temperature with the use of ELISA POD Substrate TMB Kit (available from Nacalai Tesque, Inc.) serving as a color developing solution. Thirty minutes after 100 μL substrate solution was added, 100 μL post-reaction stop solution was added and a 450 nm light absorbance was measured.

For acetyl-NH-TEETIWWWK-COOH turned into solid phase with PEG-DG such that the chain length was 11.0 Å and the degree of polymerization was the inclination of the 450 nm light absorbance was linear in the cases of antigen Cryj1 concentrations of 0 μg/mL, 0.2 μg/mL, 0.5 μg/mL, 1.0 μg/mL, and 2.0 μg/mL.

For acetyl-NH-TEYTIHWWK-COOH(SH1) serving as the artificially synthesized Cry-J1 recognition peptide, a solid phase was carried out in accordance with example 2. The poly(or mono)ethylene glycol diglycidyl ether (PEG-DG) that was used was such that the chain length was 11.0 Å and the degree of polymerization was n=2.

For acetyl-NH-TEYTIHWWK-COOH turned into solid phase, the inclination of the 450 nm light absorbance was linear in the cases of antigen Cryj1 concentrations of 0 μg/mL, 0.2 μg/mL, 0.5 μg/mL, 1.0 ng/mL, and 2.0 μg/mL.

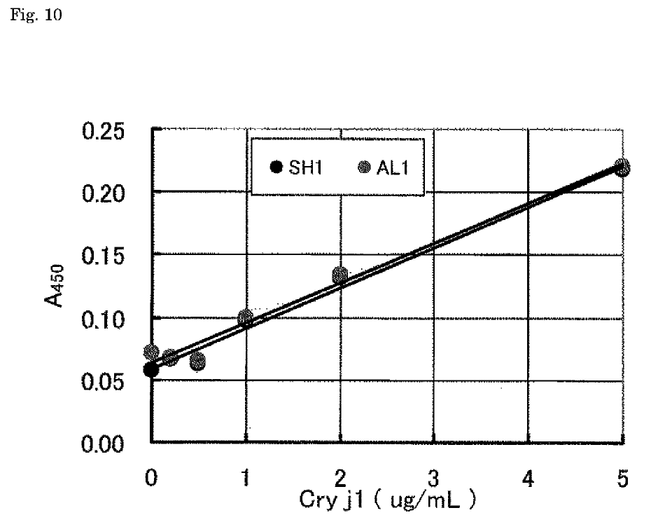

FIG. 10 shows a graph of poly(or mono)ethylene glycol diglycidyl ether (PEG-DG) linker length (Angstrom unit) on the horizontal axis and light absorbance on the vertical axis, thus denoting the inclination as detection efficiency.

As seen from FIG. 10, it has been found that acetyl-NH-TEYTIHWWK-COOH (SH1) and acetyl-NH-TEETIWWWK-COOH (AL1) exhibit substantially the same reactivity with respect to Cry-J1. A possible reason for this is that the amino acid sequence TEYTIHWWK was sufficiently capable both in hydrophilicity and hydrophobicity for recognition of Cry-J1. Therefore, the artificially synthesized peptide TEETIWWWK, in which a part of the hydrophilicity and a part of the hydrophobicity were improved, possibly went no further than to exhibit the same recognizability as the artificially synthesized peptide TEYTIHWWK, in which lysine was added to the C terminal of the hypervariable area.

### INDUSTRIAL APPLICABILITY

As has been described hereinbefore, the present invention realizes, at low cost, a biosensor that eliminates the possibility of deactivation. This biosensor finds applications in environment measurement devices, medical examination apparatuses, and the like. Thus, the industrial applicability is enormous.

1. A biosensor for capturing and detecting a recognition target substance, the biosensor comprising:
a peptide serving as a molecular recognition substance;
a linker made of a hydrocarbon compound having two or more particular functional groups; and
a support,
wherein the peptide is directly bonded to one of the particular functional groups of the linker while the support is directly bonded to the other particular functional group of the linker bonded to the peptide.

2. The biosensor according to claim 1, wherein the particular functional groups each are a reaction product functional group of an epoxy group and an amino group.

3. The biosensor according to claim 1, comprising the two particular functional groups, wherein one of the particular functional groups is located at one terminal of the linker, and the other particular functional group is located at the other terminal of the linker.

4. The biosensor according to claim 1, wherein a structure of the linker other than a portion for the particular functional group is a hydrocarbon structure having hydrophilicity, hydrophobicity, or amphiphaticity.

5. The biosensor according to claim 1, wherein the linker has an alkylene oxide structure represented by “—O—CH₂—CHR—; R denoting a hydrogen atom or an alkyl group.”

6. The biosensor according to claim 1, wherein as the peptide, an artificially synthesized peptide is used.

7. The biosensor according to claim 6, wherein the artificially synthesized peptide is identical to an amino acid sequence in a hypervariable area of an antibody protein, or an artificially synthesized peptide in which some functional group of an amino acid of the amino acid sequence is modified, or an artificially synthesized peptide in which another amino acid is added to a C terminal and/or an N terminal of the amino acid sequence, or an artificially synthesized peptide in which a part of the amino acid sequence is changed.

8. The biosensor according to claim 6, wherein an amino acid at a C terminal and/or an N terminal of the artificially synthesized peptide is cysteine.

9. The biosensor according to claim 6, wherein:
an amino group of an amino acid at the N terminal of the artificially synthesized peptide is modified;
an amino acid at the C terminal of the artificially synthesized peptide is an amino acid having primary amine on a side chain; and
an amino group of the amino acid at the C terminal is bonded to the particular functional group.

10. The biosensor according to claim 9, wherein the amino acid at the C terminal is lysine.

11. The biosensor according to claim 1, wherein the length of the linker is from 0.5 to 10 nm.

12. The biosensor according to claim 1, wherein the length of the linker is from 0.8 to 7.0 nm.

13. The biosensor according to claim 1, comprising a single kind of peptide to be immobilized to the support.

14. The biosensor according to claim 1, comprising two or more kinds of peptides to be immobilized to the support, the peptides existing in a random manner.

15. The biosensor according to claim 1, whereon the support has formed thereon a molecule recognition area A where a plurality of peptides of a single kind are immobilized, and a molecule recognition area B where a plurality of peptides of a single kind different from the foregoing are immobilized.

16. The biosensor according to claim 1, whereon the support is a substrate, a solid particle, a film, a fiber, or a gel.

17. The biosensor according to claim 1, whereon the support is a thin film formed on a surface of a substrate, a solid particle, a fiber, or a gel.

18. The biosensor according to claim 17, wherein the thin film is chitosan of 50 to 400 nm thick.

19. A method for producing a biosensor comprising the step of bringing a mixture solution of a peptide serving as a molecular recognition substance and a linker molecule made of a hydrocarbon compound with epoxy groups at both terminals thereof into contact with a support having on a surface thereof a functional group that bonds to an epoxy group, in order to directly bond the peptide to the linker molecule and directly bond the linker molecule to the support.

20. The method for producing a biosensor according to claim 19, wherein the concentration of the peptide contained in the mixture solution is from 0.001 to 2.0 mole/L.

21. The method for producing a biosensor according to claim 19, wherein the concentration of the linker molecule contained in the mixture solution is from 0.001 to 4.0 mole/L.

22. The method for producing a biosensor according to claim 19, wherein the linker molecule is polyalkylene oxide diglycidyl ether or monoalkylene oxide diglycidyl ether represented by G-(O—CH₂—CHR—)ₙ—O-G, where R denotes a hydrogen atom or an alkyl group, G denotes a glycidyl group, and n denotes an integer of 1 or greater.

23. The method for producing a biosensor according to claim 19, wherein the functional group on the surface of the support is an amino group.

24. The method for producing a biosensor according to claim 23, whereon the support is a thin film formed by applying a chitosan solution having chitosan dissolved in an acid solvent solution to a surface of a substrate, a solid particle, a fiber, or a gel.

25. The method for producing a biosensor according to claim 24, wherein the chitosan solution has a viscosity of from 100 to 1000 Pa·S at 25° C.

26. The method for producing a biosensor according to claim 25, wherein the chitosan thin film has a thickness of from 50 to 400 nm.

27. A method for detecting a recognition target substance using a biosensor set forth in claim 7, comprising:
a first step of forming a peptide/recognition target substance composite by reacting the peptide with the recognition target substance;
a second step of forming peptide/recognition target substance composite/fluorescent substance-added antibody material by reacting the peptide/recognition target substance composite with a fluorescent substance-added antibody material;
a third step of rinsing an excessive portion of the fluorescent substance-added antibody material;
a fourth step of detecting the amount of a fluorescent substance;
a fifth step of adding gold colloid in order to react cysteine with the gold colloid;
a sixth step of rinsing an excessive portion of the gold colloid and the fluorescent substance-added antibody material; and
a seventh step of, after the sixth step, detecting the amount of the fluorescent substance,
wherein the amount of the recognition target substance is measured from a difference between the amount of the fluorescent substance detected in the fourth step and the amount of the fluorescent substance detected in the seventh step.

28. A method for detecting a recognition target substance using a biosensor set forth in claim 1, comprising:
a first step of forming a peptide/recognition target substance composite by reacting the peptide and the recognition target substance to one another;
a second step of forming peptide/recognition target substance composite/cysteine-added peptide by reacting the peptide/recognition target substance composite and a peptide with cysteine added to a terminal;
a third step of rinsing an excessive portion of the peptide with cysteine added to a terminal;
a fourth step of adding gold colloid in order to react the cysteine with the gold colloid;
a fifth step of rinsing an excessive portion of the gold colloid; and
a sixth step of, after the sixth step, detecting the amount of color development of the gold colloid.

29. A biosensor comprising:
a peptide serving as a molecule capturing substance for capturing a particular molecule;
a support for holding the peptide; and
a linker for linking the peptide to the support, wherein:
the peptide is an artificially synthesized peptide of a structure different from an immunoglobulin of living body;
the linker is a hydrocarbon compound having at least two reactive functional groups; and
the artificially synthesized peptide is directly bonded to one of the reactive functional groups of the linker, and the support is directly bonded to another reactive functional group different from the foregoing reactive functional group.

30. The biosensor according to claim 29, wherein the artificially synthesized peptide includes three or more consecutive amino acid sequences among amino acid sequences of a natural immunoglobulin, the three or more consecutive amino acid sequences existing in a part corresponding to a hypervariable area of the natural immunoglobulin.

31. The biosensor according to claim 30, wherein some of functional groups of amino acids constituting the three or more amino acid sequences are modified by other functional groups.

32. The biosensor according to claim 29, wherein assuming that an amino acid sequence composed of four consecutive amino acids forming a hypervariable area of a natural immunoglobulin is a hydrophobic amino acid sequence when three of the amino acids constituting the amino acid sequence each are a hydrophobic amino acid selected from a group consisting of isoleucine, phenylalanine, valine, leucine, methionine, tryptophan, alanine, glycine, cysteine, and tyrosine, and the other one amino acid is an amino acid other than the hydrophobic amino acid, then the artificially synthesized peptide contains a synthesized hydrophobic amino acid sequence unit resulting from replacing the amino acid other than the hydrophobic amino acid in the hydrophobic amino acid sequence with a hydrophobic amino acid.

33. The biosensor according to claim 32, wherein some functional groups of the amino acids constituting the synthesized hydrophobic amino acid sequence unit are replaced with other functional groups.

34. The biosensor according to claim 29, wherein assuming that an amino acid sequence composed of four consecutive amino acids forming a hypervariable area of a natural immunoglobulin is a hydrophilic amino acid sequence when three of the amino acids constituting the amino acid sequence each are a hydrophilic amino acid selected from a group consisting of histidine, glutamic acid, asparatic acid, glutamine, asparagine, lysine, arginine, proline, threonine, and serine, and the other one amino acid is an amino acid other than the hydrophilic amino acid, then the artificially synthesized peptide contains a synthesized hydrophilic amino acid sequence unit resulting from replacing the amino acid other than the hydrophilic amino acid in the hydrophilic amino acid sequence with a hydrophilic amino acid.

35. The biosensor according to claim 34, wherein some functional groups of the amino acids constituting the synthesized hydrophilic amino acid sequence unit are replaced with other functional groups.

36. The biosensor according to claim 29, wherein an amino acid at an N terminal of the artificially synthesized peptide is bonded to the linker.

37. The biosensor according to claim 29, wherein:
an amino acid at an N terminal of the artificially synthesized peptide is modified;
an amino acid at a C terminal of the artificially synthesized peptide is an amino acid having primary amine on a side chain; and
the amino acid at the C terminal of the artificially synthesized peptide is bonded to the linker.

38. The biosensor according to claim 37, wherein the amino acid at the C terminal is lysine.

39. The biosensor according to claim 29, wherein:
an amino acid at an N terminal of the artificially synthesized peptide is an amino acid having primary amine on a side chain;
an α-amino group of the amino acid at the N terminal is modified; and
the amino acid at the N terminal of the artificially synthesized peptide is bonded to the linker.

40. The biosensor according to claim 39, wherein the amino acid at the N terminal is lysine.

41. The biosensor according to claim 29, wherein:
an α-amino group of an amino acid at an N terminal of the artificially synthesized peptide is not modified;
an amino acid at a C terminal of the artificially synthesized peptide is an amino acid having primary amine on a side chain; and
the amino acid at the N terminal of the artificially synthesized peptide is bonded to one linker, and the amino acid at the C terminal of the artificially synthesized peptide is bonded to another linker.

42. The biosensor according to claim 41, wherein the amino acid at the N terminal is lysine.

43. The biosensor according to claim 29, wherein:
an amino acid at an N terminal of the artificially synthesized peptide is an amino acid having primary amine on a side chain;
an amino acid at a C terminal of the artificially synthesized peptide is an amino acid having primary amine on a side chain;
α-amino group of the N terminal is modified; and
the amino acid at the N terminal of the artificially synthesized peptide is bonded to one linker, and the amino acid at the C terminal of the artificially synthesized peptide is bonded to another linker.

44. The biosensor according to claim 43, wherein the amino acid at the N terminal and the amino acid at the C terminal are lysine.

45. The biosensor according to claim 37, wherein the length of the linker is from 0.5 to 1.5 nm.

46. The biosensor according to claim 36, wherein the length of the linker is from 2.0 to 6.0 nm.

47. The biosensor according to claim 41, wherein the length of the linker is from 0.5 to 10 nm.

48. The biosensor according to claim 29, wherein the bonding of the one reactive functional group of the linker to the artificially synthesized peptide results from a reaction of an epoxy group and an amino group.

49. The biosensor according to claim 29, wherein the bonding of the other reactive functional group of the linker to the support results from a reaction of an epoxy group and an amino group.

50. The biosensor according to claim 29, wherein the linker has an alkylene oxide structure represented by “—O—CH₂—CHR—; R denoting a hydrogen atom or an alkyl group.”

51. The biosensor according to claim 29, wherein the artificially synthesized peptide contains a natural hydrophobic amino acid sequence unit composed of four consecutive hydrophobic amino acids each selected from a group consisting of isoleucine, phenylalanine, valine, leucine, methionine, tryptophan, alanine, glycine, cysteine, and tyrosine, the natural hydrophobic amino acid sequence unit being a sequence of four consecutive amino acids in a hypervariable area of a natural immunoglobulin.

52. The biosensor according to claim 29, wherein the artificially synthesized peptide contains a natural hydrophilic amino acid sequence unit composed of four consecutive hydrophilic amino acids each selected from a group consisting of histidine, glutamic acid, asparatic acid, glutamine, asparagine, lysine, arginine, proline, threonine, and serine, the natural hydrophobic amino acid sequence unit being a sequence of four consecutive amino acids in a hypervariable area of a natural immunoglobulin.
